(19) United States
(12) Patent Application Publication
(10) Pub. No.: US 2024/0349193 A1
(43) Pub. Date: Oct. 17, 2024

(54) TRANSMISSION DEVICE, COMMUNICATION SYSTEM, TRANSMISSION METHOD, AND PROGRAM

(71) Applicants: SEIKO GROUP CORPORATION, Tokyo (JP); Tokyo University of Science Foundation, Tokyo (JP)

(72) Inventors: Ryosuke ISOGAI, Matsudo-shi, Chiba (JP); Yoshifumi YOSHIDA, Matsudo-shi, Chiba (JP); Mikio HASEGAWA, Tokyo (JP); Ryoma KITAGAWA, Tokyo (JP); Hiroyuki YASUDA, Tokyo (JP); Aohan LI, Tokyo (JP)

(21) Appl. No.: 18/683,707

(22) PCT Filed: Aug. 3, 2022
(86) PCT No.: PCT/JP2022/029806

§ 371 Date: Feb. 14, 2024

(30) Foreign Application Priority Data
Aug. 20, 2021 (JP) 2021-134595

(51) Int. Cl. H04W 52/02

(52) U.S. Cl. CPC H04W 52/0238

(57) ABSTRACT

A transmission device for performing information communication with one or more reception devices includes a communication history information storage unit configured to store communication history information in which a communication parameter for performing the information communication is associated with a deterioration rate that is a value based on radio waves transmitted using the communication parameter when information is transmitted to the reception device and radio waves received from the reception device, a calculation unit configured to calculate the communication parameter when communication with the reception device is performed on the basis of the stored communication history information, and an output unit configured to output the calculated communication parameter.

### RELATED APPLICATIONS

This application is a 371 application of PCT/JP2022/029806 having an international filing date of Aug. 3, 2022, which claims priority to Japanese Patent Application No. 2021-134595, filed Aug. 20, 2021, the entire content of each of which is incorporated herein by reference.

### TECHNICAL FIELD

The present invention relates to a transmission device, a communication system, a transmission method, and a program.

### BACKGROUND ART

Conventionally, in a wireless communication system including a transmission device and a reception device, there is a wireless communication method using a plurality of channels with different frequencies when information is transmitted from the transmission device to the reception device. In such a wireless communication system, there is technology for preventing unnecessary power consumption without using a detected channel when wireless communication interference is detected (see, for example, Patent Document 1).

### CITATION LIST

### Patent Document

### [Patent Document 1]

Japanese Unexamined Patent Application, First Publication No. 2018-157429

### SUMMARY OF INVENTION

### Technical Problem

According to the above-described conventional technology, reliability is sacrificed by not using a channel on which wireless communication interference has been detected. That is, according to the conventional technology, power consumption may be suppressed as a result of a trade-off with reliability. However, according to such technology, it is not easy to suppress power consumption while maintaining reliability.

Therefore, an objective of the present invention is to provide communication technology for suppressing power consumption while maintaining reliability.

### Solution to Problem

According to an aspect of the present invention, there is provided a transmission device for performing information communication with one or more reception devices, the transmission device including: a communication history information storage unit configured to store communication history information in which a communication parameter for performing the information communication is associated with a deterioration rate that is a value based on radio waves transmitted using the communication parameter when information is transmitted to the reception device and radio waves received from the reception device; a calculation unit configured to calculate the communication parameter when communication with the reception device is performed on the basis of the stored communication history information; and an output unit configured to output the calculated communication parameter.

Also, in the transmission device according to the aspect of the present invention, the calculation unit is trained on the basis of the deterioration rate obtained from an information communication result using the communication parameter output by the output unit using a machine learning algorithm.

Also, in the transmission device according to the aspect of the present invention, the calculation unit is trained using a multi-armed bandit algorithm.

Also, in the transmission device according to the aspect of the present invention, the calculation unit calculates the communication parameter on the basis of power consumption caused by transmitting radio waves using the communication parameter included in the communication history information and the deterioration rate corresponding thereto.

Also, in the transmission device according to the aspect of the present invention, the calculation unit calculates the communication parameter for reducing the power consumption.

Also, in the transmission device according to the aspect of the present invention, the calculation unit is trained using an upper confidence bound (UCB)1 algorithm.

Also, in the transmission device according to the aspect of the present invention, the calculation unit is trained using a tug of war (TOW) algorithm.

Also, in the transmission device according to the aspect of the present invention, the calculation unit calculates the communication parameter on the basis of a plurality of communication history information items obtained from results of communicating with a plurality of reception devices.

Also, in the transmission device according to the aspect of the present invention, the deterioration rate is binary.

Also, in the transmission device according to the aspect of the present invention, the deterioration rate indicates whether or not communication with the reception device has succeeded.

Also, in the transmission device according to the aspect of the present invention, the deterioration rate is based on information about a radio wave strength included in radio waves received from the reception device.

Also, in the transmission device according to the aspect of the present invention, a signal transmitted to the reception device on the basis of the output communication parameter is encoded in an encoding scheme having an error detection function, and the deterioration rate is based on an error rate when a signal received from the reception device has been decoded.

Also, in the transmission device according to the aspect of the present invention, the communication history information storage unit stores a plurality of communication history information items, and the calculation unit performs a calculation process by more strongly weighting newer information among the plurality of communication history information items.

Also, in the transmission device according to the aspect of the present invention, the communication history information is associated with a parameter identifier for identifying the communication parameter, and the calculation unit decides on the communication parameter on the basis of accumulated communication parameters and a result of performing the information communication using the communication parameters.

Also, in the transmission device according to the aspect of the present invention, the communication parameter includes a plurality of components, and the calculation unit calculates the communication parameter by selecting one of combinations of the plurality of components included in the communication parameter.

Also, in the transmission device according to the aspect of the present invention, the information communication is a communication method in which a plurality of communication channels are defined in a predetermined frequency band, and the communication parameter includes a channel mask for identifying one or more channels that are included in the communication channels and are not used for the information communication to be performed with the reception device.

Also, in the transmission device according to the aspect of the present invention, it is indicated that radio waves transmitted to the reception device do not deteriorate as the deterioration rate decreases, and the calculation unit decides on the communication parameter so that the deterioration rate decreases when communication with a specific other party is performed via the channel mask included in the calculated communication parameter.

Also, in the transmission device according to the aspect of the present invention, the information communication is wireless communication conforming to a Bluetooth low energy (BLE) standard.

Also, in the transmission device according to the aspect of the present invention, the communication method is advertising defined in a BLE standard, and the communication channel is an advertising channel defined in the BLE standard.

Also, in the transmission device according to the aspect of the present invention, the advertising is connectable advertising, and the deterioration rate is a value calculated on the basis of whether or not a connection request has been answered.

Also, in the transmission device according to the aspect of the present invention, the advertising is advertising for receiving a scan request, and the deterioration rate is calculated on the basis of whether or not the scan request has been answered.

Also, in the transmission device according to the aspect of the present invention, the deterioration rate is calculated on the basis of the number of times one or more specific reception devices have received an advertising packet.

Also, the transmission device according to the aspect of the present invention further includes a wireless communication unit configured to perform the information communication with the reception device on the basis of the communication parameter output by the output unit, wherein the communication parameter includes a first transmission interval, and wherein the wireless communication unit transmits a signal to the reception device on the basis of the first transmission interval.

Also, in the transmission device according to the aspect of the present invention, the wireless communication unit completes an information transmission process for the reception device during a transmission time period that is a time period from a start of signal generation to an end of transmission, and the calculation unit adjusts the communication parameter so that the transmission time period is decreased when the reception device has continuously and stably received information transmitted by the wireless communication unit.

Also, in the transmission device according to the aspect of the present invention, the wireless communication unit performs a transmission process that is iterated during a period from the time of system activation to an assumed operating lifespan, and the calculation unit adjusts the communication parameter so that a total time period required for the information transmission process is decreased when the reception device has continuously and stably received information transmitted by the wireless communication unit.

Also, in the transmission device according to the aspect of the present invention, the communication parameter includes a second transmission interval and a transmission count, and the wireless communication unit transmits second data different from first data on the basis of the second transmission interval after the first data obtained by encoding the same data is transmitted until a specific transmission count is reached on the basis of the first transmission interval.

Also, in the transmission device according to the aspect of the present invention, the calculation unit adjusts the communication parameter so that the transmission count is decreased when the reception device has continuously and stably received information transmitted by the wireless communication unit.

Also, in the transmission device according to the aspect of the present invention, the calculation unit adjusts the communication parameter so that the second transmission interval is increased when the reception device has continuously and stably received information transmitted by the wireless communication unit.

Also, in the transmission device according to the aspect of the present invention, the calculation unit adjusts the communication parameter so that the second transmission interval is increased when the reception device has not continuously received information transmitted by the wireless communication unit.

Also, in the transmission device according to the aspect of the present invention, the calculation unit adjusts the communication parameter so that the first transmission interval is decreased when the reception device has continuously and stably received information transmitted by the wireless communication unit.

Also, in the transmission device according to the aspect of the present invention, the second transmission interval is a time interval based on a random value.

Also, in the transmission device according to the aspect of the present invention, the first transmission interval is a time interval based on a random value.

Also, in the transmission device according to the aspect of the present invention, the communication parameter includes a strength of a radio signal in the information communication to be performed with the reception device.

Also, in the transmission device according to the aspect of the present invention, the calculation unit adjusts the communication parameter so that the strength is decreased when the reception device has continuously and stably received information transmitted by the wireless communication unit.

According to an aspect of the present invention, there is provided a communication system including: the transmission device according to any one of the above-described aspects; and the reception device configured to perform the information communication with the transmission device, wherein the reception device includes a reception-side communication history information storage unit configured to store the communication history information, and wherein the reception device and the transmission device share the communication history information.

According to an aspect of the present invention, there is provided a transmission method of performing information communication with one or more reception devices, the transmission method including: a communication history information storage step of storing communication history information in which a communication parameter for performing the information communication is associated with a deterioration rate that is a value based on radio waves transmitted using the communication parameter when information is transmitted to the reception device and radio waves received from the reception device; a calculation step of calculating the communication parameter when communication with the reception device is performed on the basis of the stored communication history information; and an output step of outputting the calculated communication parameter.

According to an aspect of the present invention, there is provided a program for causing a computer for performing information communication with one or more reception devices to execute: a communication history information storage step of storing communication history information in which a communication parameter for performing the information communication is associated with a deterioration rate that is a value based on radio waves transmitted using the communication parameter when information is transmitted to the reception device and radio waves received from the reception device; a calculation step of calculating the communication parameter when communication with the reception device is performed on the basis of the stored communication history information; and an output step of outputting the calculated communication parameter.

### Advantageous Effects of Invention

According to the present invention, it is possible to provide communication technology for suppressing power consumption while maintaining reliability.

### BRIEF DESCRIPTION OF DRAWINGS

FIG. 1 is a diagram for describing an example of a device configuration of a communication system according to an embodiment.

FIG. 2 is a diagram for describing an example of information communication of the communication system according to the embodiment.

FIG. 3 is a block diagram showing an example of a functional configuration of a transmission device according to the embodiment.

FIG. 4 is a diagram showing an example of communication history information according to the embodiment.

FIG. 5 is a diagram for describing a series of operations of the transmission device according to the embodiment.

FIG. 6 is a diagram for describing a search and utilization of communication parameters according to the embodiment.

FIG. 7 is a timing chart showing an example of timings of data transmitted by the transmission device according to the embodiment.

FIG. 8 is a diagram which shows a modified example of the communication history information according to the embodiment.

FIG. 9 is a diagram for describing an example in which a parameter identifier is used according to the embodiment.

FIG. 10 is a diagram for describing an example in which the communication history information is weighted according to the embodiment.

FIG. 11 is a diagram for describing an example in which guideline information is occupied by one transmission device according to the embodiment.

FIG. 12 is a diagram for describing an example in which the guideline information is shared by a plurality of transmission devices according to the embodiment.

### DESCRIPTION OF EMBODIMENTS

### [Communication System]

Hereinafter, embodiments of the present invention will be described with reference to the drawings. The embodiments to be described below are only examples and the embodiments to which the present invention applies are not limited to the following embodiments.

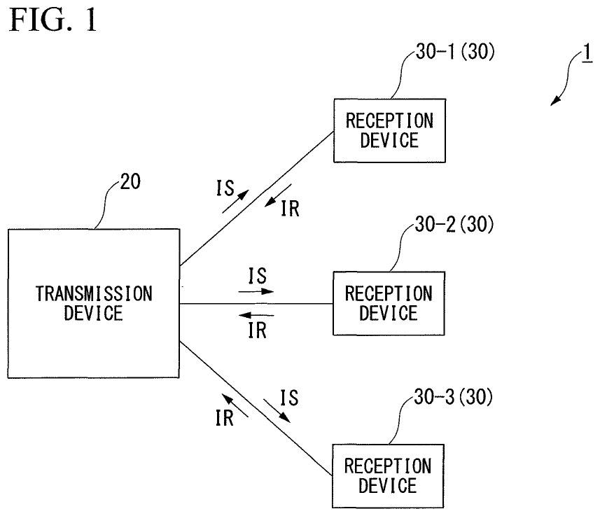

FIG. 1 is a diagram for describing an example of a device configuration of a communication system according to the embodiment. The communication system 1 will be described with reference to the drawings.

The communication system 1 includes a transmission device 20 and a reception device 30. The transmission device 20 and the reception device 30 perform information communication with each other. The communication system 1 may include a plurality of transmission devices 20 and a plurality of reception devices 30. In this case, each transmission device 20 performs information communication with one or more reception devices 30. A case where one transmission device 20 and a plurality of reception devices 30 are provided will be described as an example of the communication system 1 with reference to FIG. 1. Specifically, a case where a reception device 30-1, a reception device 30-2, and a reception device 30-3 are provided as an example of the reception device 30 will be described.

The transmission device 20 and the reception device 30 perform information communication with each other through short-range wireless communication using near field communication (NFC). An example in which the transmission device 20 and the reception device 30 perform wireless communication conforming to the standard of Bluetooth (registered trademark) (Bluetooth), particularly information communication based on wireless communication conforming to the standard of Bluetooth low energy (BLE), will be described below as an example of the short-range wireless communication.

The short-range wireless communication in the present embodiment is not limited to the example of BLE and various communication schemes can be employed. For example, the short-range wireless communication may be Wi-Fi (registered trademark), infrared data association (IrDA), TransferJet (registered trademark), ZigBee (registered trademark), and the like. Alternatively, the wireless communication is not limited to a short range, but may be low power wide area (LPWA) or the like.

When the communication system 1 performs information communication based on wireless communication conforming to the BLE standard, the transmission device 20 may be peripheral and the reception device 30 may be central.

The transmission device 20, which is peripheral, transmits transmission information IS without identifying the reception device 30. The reception device 30 located in the vicinity of the transmission device 20 transmits reception information IR when the transmission information IS has been received.

The information communication performed between the transmission device 20 and the reception device 30 may be a communication method in which a plurality of communication channels are defined in a predetermined frequency band. For example, the transmission device 20 and the reception device 30 may exchange information using an advertising packet in wireless communication conforming to the BLE standard.

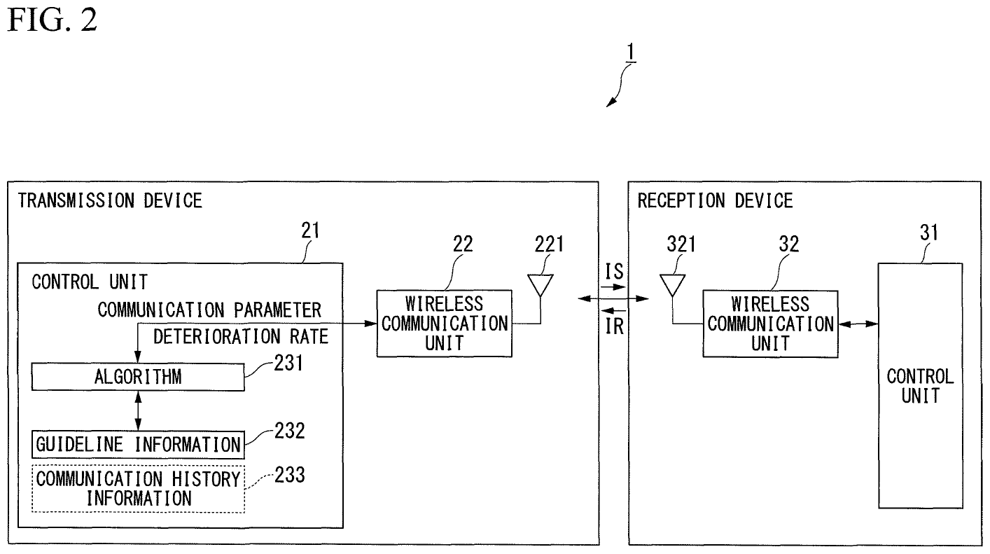

FIG. 2 is a diagram for describing an example of information communication in the communication system according to the embodiment. An example of information communication performed between the transmission device 20 and the reception device 30 provided in the communication system 1 will be described with reference to FIG. 2.

The transmission device 20 transmits transmission information IS on the basis of communication parameters calculated in an algorithm 231. The communication parameters may be, for example, a frequency band for use in communication, a signal transmission interval, a transmission count, transmission power, or the like.

The transmission device 20 includes a control unit 21 and a wireless communication unit 22.

The wireless communication unit 22 controls radio waves to be transmitted from an antenna 221 on the basis of the communication parameters acquired from the control unit 21. Also, the wireless communication unit 22 outputs information based on the radio waves received by the antenna 221 to the control unit 21.

The control unit 21 includes the algorithm 231 and calculates the communication parameters. The control unit 21 includes the algorithm 231 to calculate the communication parameters on the basis of communication history information 233. The control unit 21 updates the calculated communication parameters as guideline information 232 at any time. The control unit 21 outputs the calculated communication parameters to the wireless communication unit 22.

Also, the control unit 21 acquires information of radio waves received by the antenna 221 from the wireless communication unit 22. The control unit 21 updates the guideline information 232 on the basis of a deterioration rate included in the acquired radio wave information.

The deterioration rate is a value indicating a degree of deterioration of communication quality, and may be calculated on the basis of, for example, whether or not the transmission information IS transmitted by the transmission device 20 has reached one of the reception devices 30. That is, the deterioration rate may be a value indicating whether or not communication between the transmission device 20 and the reception device 30 has been successful. In this case, the deterioration rate may be binary. When the deterioration rate is binary, the control unit 21 is calculated according to a control signal (for example, an ACK signal or the like) that is returned when the reception device 30 has correctly received the transmission information IS or the like.

As another embodiment of the control signal, the presence or absence of a scan response request for the BLE advertising packet may be used as the deterioration rate, and the presence or absence of a connection request from the central device (i.e., the reception device 30) may be used as the deterioration rate. The reception device 30 may convey whether or not the transmission information IS has been correctly received using different communication means without involving wireless communication. The control unit 21 sets a low deterioration rate when the reception device 30 has correctly received the transmission information IS. The control unit 21 may set the deterioration rate to 0 (zero) when the reception device 30 has correctly received the transmission information IS.

Also, in another embodiment, the deterioration rate may be based on information about the strength of radio waves contained in the radio waves received by the antenna 221 from the reception device 30. The information about the strength of the radio waves may be, for example, a received signal strength indicator (RSSI) or the like. In this case, the reception device 30 includes a radio wave strength measurement unit (not shown) and measures the radio wave strength when receiving the transmission information IS. The reception device 30 transmits the measured radio wave strength to the transmission device 20 as reception information IR. The control unit 21 sets the deterioration rate to a higher rate when the radio wave strength included in the received reception information IR is lower. That is, it is indicated that the radio waves transmitted to the reception device 30 do not deteriorate as the deterioration rate decreases.

Furthermore, as another embodiment, the deterioration rate may be calculated from an error rate when the reception device 30 has received information encoded with an error detection code or an error correction code. In this case, the control unit 31 provided in the reception device 30 calculates the error rate of the transmission information IS acquired from the transmission device 20. The reception device 30 transmits the calculated error rate as the reception information IR to the transmission device 20. The control unit 21 provided in the transmission device 20 sets the deterioration rate to a higher rate when the error rate included in the received reception information IR is higher.

In other words, a signal transmitted to the reception device 30 on the basis of the output communication parameters is encoded in an encoding scheme having an error detection function and the deterioration rate is based on the error rate when a signal received from the reception device 30 has been decoded.

The reception device 30 includes a control unit 31 and a wireless communication unit 32.

The wireless communication unit 32 receives radio waves from the transmission device 20 via the antenna 321. The control unit 31 calculates the radio wave strength (RSSI) of the received radio waves, the error rate, and the like on the basis of received radio wave information input from the wireless communication unit 32. The wireless communication unit 32 outputs the radio wave strength, the error rate, and the like calculated by the control unit 31 as the reception information IR.

Here, the transmission device 20 and the reception device 30 may have similar device configurations. That is, in the communication system 1, a device that performs the behavior of the transmission side at a certain point in time is referred to as the transmission device 20 and a device that receives radio waves transmitted by the transmission device 20 is referred to as the reception device 30. In the following description, when the transmission device 20 and the reception device 30 are not distinguished, they are also referred to as the communication device 10.

### [Functional Configuration of Transmission Device]

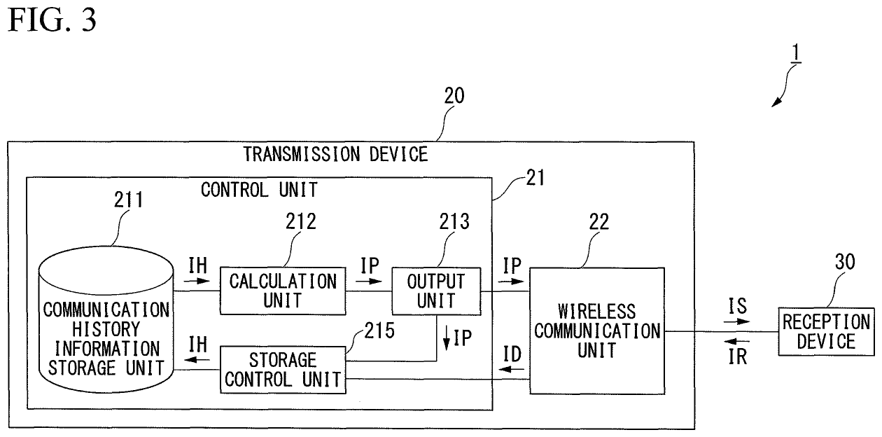

FIG. 3 is a block diagram showing an example of the functional configuration of the transmission device according to the embodiment. The functional configuration of the transmission device 20 will be described with reference to FIG. 3. The components already described in the description of the communication system 1 are denoted by similar reference signs and description thereof may be omitted.

The transmission device 20 includes a control unit 21 and a wireless communication unit 22. The transmission device 20 includes a storage device such as a central processing unit (CPU), a read-only memory (ROM), or a random access memory (RAM) connected by a bus and the like, and functions as a device including the control unit 21 and the wireless communication unit 22 by executing a transmission program.

The control unit 21 includes a communication history information storage unit 211, a calculation unit 212, an output unit 213, and a storage control unit 215.

In addition, all or some functions of the transmission device 20 may be implemented using hardware such as an application-specific integrated circuit (ASIC), a programmable logic device (PLD), or a field-programmable gate array (FPGA). The transmission program may be recorded on a computer-readable recording medium. The computer-readable recording medium is, for example, a flexible disk, a magneto-optical disc, a ROM, a portable medium such as a CD-ROM, or a storage device such as a hard disk built into a computer system. The transmission program may be transmitted via a telecommunication circuit.

The communication history information storage unit 211 stores communication history information IH.

The communication history information IH is information in which a communication parameter PM for performing information communication is associated with a deterioration rate D when information communication is performed using the communication parameter PM. The deterioration rate D is a value based on the radio waves transmitted using the communication parameter PM when information is transmitted to the reception device 30 and the radio waves received from the reception device 30. For example, the deterioration rate D may be defined by the deterioration rate D=(radio wave strength of received radio waves/radio wave strength of transmitted radio waves). The communication history information storage unit 211 may include a volatile RAM or a non-volatile ROM.

Here, the communication history information IH stored in the communication history information storage unit 211 will be described with reference to the drawings.

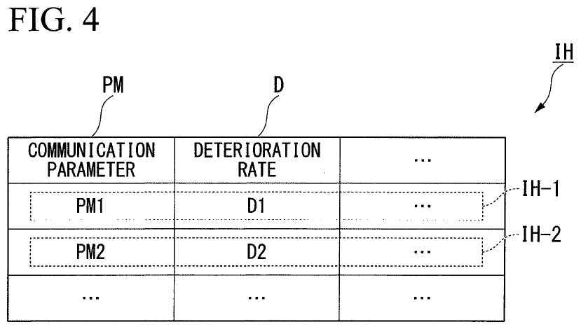

FIG. 4 is a diagram showing an example of communication history information according to the embodiment. The communication history information IH will be described with reference to FIG. 4. As shown in FIG. 4, the communication parameter PM and the deterioration rate D are associated and stored as the communication history information IH in the communication history information storage unit 211. In the example shown in FIG. 4, specifically, the communication parameter PM1 and the deterioration rate D1 are associated and stored as communication history information IH-1 and the communication parameter PM2 and the deterioration rate D2 are associated and stored as communication history information IH-2.

The calculation unit 212 decides on the communication parameter on the basis of accumulated communication parameters PM and a result of performing information communication using the communication parameters PM. The result of performing the information communication is, for example, the deterioration rate D.

Returning to FIG. 3, the calculation unit 212 calculates the communication parameter PM to be used when communication with the reception device 30 is performed on the basis of the communication history information IH stored in the communication history information storage unit 211. Specifically, the calculation unit 212 calculates the communication parameter PM using a machine learning algorithm. The machine learning algorithm may be, for example, a reinforcement learning algorithm using state information such as Q learning or deep reinforcement learning. When the machine learning algorithm is a reinforcement learning algorithm, the communication parameter PM for maximizing the reward is learned using the deterioration rate D as a reward in the machine learning algorithm.

Here, the machine learning algorithm may be a pre-trained model. In addition, at the time of the initial operation, the machine learning algorithm may not be trained. Therefore, when the machine learning algorithm is untrained, a result may be determined according to a random number.

The machine learning algorithm is learned on the basis of the communication history information UH. The communication history information IH is information in which the communication parameter PM output by the output unit 213 is associated with the deterioration rate D obtained as a result of information communication using the communication parameter PM. That is, the calculation unit 212 is trained on the basis of the deterioration rate D obtained as a result of information communication using the communication parameter PM output by the output unit 213.

The calculation unit 212 outputs parameter information IP including the calculated communication parameter PM to the output unit 213.

The output unit 213 outputs the parameter information IP including the communication parameter PM calculated by the calculation unit 212 to the wireless communication unit 22.

The wireless communication unit 22 performs information communication with the reception device 30 on the basis of the communication parameter PM included in the parameter information IP output by the output unit 213.

The storage control unit 215 acquires deterioration information ID including the deterioration rate D from the wireless communication unit 22. The storage control unit 215 associates the acquired deterioration information ID with the communication parameter PM and causes the communication history information storage unit 211 to store an association result as communication history information IH. The storage control unit 215 acquires parameter information IP from at least one of the output unit 213 and the wireless communication unit 22, generates the communication history information IH by associating the communication parameter PM included in the acquired parameter information IP with the deterioration rate D, and causes the communication history information storage unit 211 to store the generated communication history information IH.

### [Series of Operations of the Transmission Device]

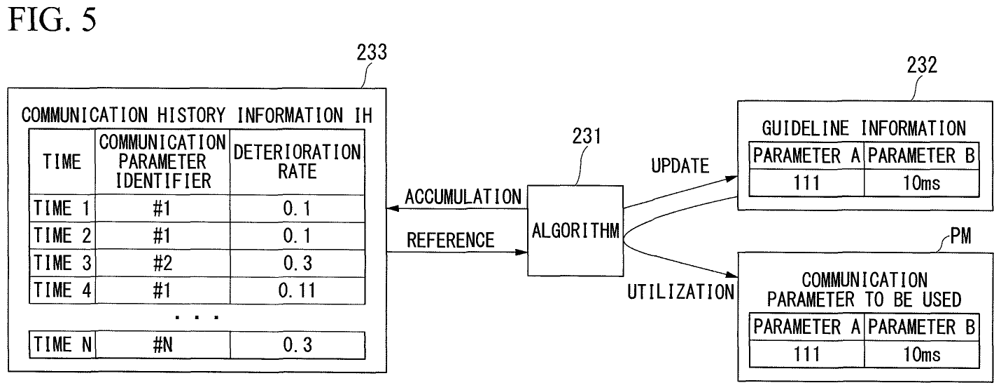

FIG. 5 is a diagram for describing a series of operations of the transmission device according to the embodiment. An example of the operations of the transmission device 20 will be described with reference to FIG. 5. The algorithm 231 is provided in the transmission device 20. The communication history information 233 is an example of the communication history information IH stored in the communication history information storage unit 211.

In the algorithm 231, the communication history information 233 is accumulated on the basis of the communication parameter PM used by the transmission device 20 for communication. In the communication history information 233, a communication parameter identifier (parameter identifier) PMID for identifying the communication parameter PM, the deterioration rate D, and a time are associated. The time is the time at which information communication is performed using the communication parameter PM identified by the parameter identifier PMID or the time at which the deterioration rate D is obtained as a result of performing information communication.

In the algorithm 231, power consumption is suppressed and a communication parameter PM with which information can be efficiently transmitted is searched for. Specifically, in the algorithm 231, an optimal communication parameter is derived at the time of information communication while “search,” which is an operation of learning a suitable communication parameter, and “utilization,” which is an operation of performing communication using the communication parameter PM decided on in the search, are iterated.

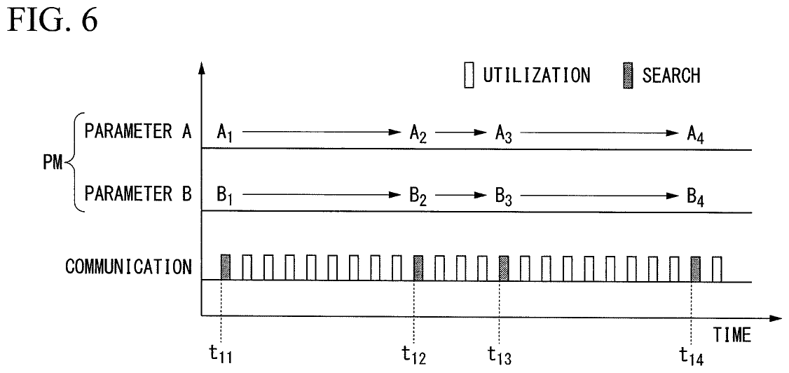

FIG. 6 is a diagram for describing the search and utilization of communication parameters according to the embodiment. “Search” and “utilization” of the algorithm 231 will be described with reference to FIG. 6.

“Parameter A” and “parameter B” are examples of communication parameters PM. That is, in one example described with reference to FIG. 6, the number of communication parameters PM is two. The time variation of each parameter is shown with the horizontal axis representing time. “Communication” indicates whether “search” or “utilization” is being performed in the algorithm 231 with the horizontal axis representing time. “Search” is indicated by a rectangle shaded in black and “utilization” is indicated by an unshaded rectangle.

At time t₁₁, “search” is performed in the algorithm 231. In the algorithm 231, the value of parameter A is decided on as “A₁” and the value of parameter B is decided on as “B₁.” During a period from time t₁₁ to time t₁₂, the transmission device 20 performs information communication using the decided communication parameter PM. That is, during a period from time t₁₁ to time t₁₂, “utilization” is performed.

At time t₁₂, “search” for a more suitable communication parameter PM is performed in the algorithm 231 on the basis of the accumulated communication history information IH as a “utilization” result during the period from time t₁₁ to time t₁₂. As a search result, a change of the value of parameter A from “A₁” to “A₂” and a change of the value of parameter B from “B₁” to “B₂” are decided on in the algorithm 231. During a period from time t₂ to time t₁₃, the transmission device 20 performs information communication using the decided communication parameter PM.

At time t₁₃, “search” for a more suitable communication parameter PM is performed on the basis of a result of “utilization” and the accumulated communication history information IH during a period from time to t₁₁ time t₁₂ and a period from time t₁₂ to time t₁₃ in the algorithm 231. As a search result, a change of the value of parameter A from “A₂” to “A₃” and a change of the value of parameter B from “B₂” to “B₃” are decided on in the algorithm 231. During a period from time t₁₃ to time t₁₄, the transmission device 20 performs information communication using the decided communication parameter PM.

As described above, in the algorithm 231, a suitable communication parameter PM is derived and information communication is performed on the basis of the derived communication parameter PM while “search” and “utilization” are iterated.

Also, in the example shown in FIG. 6, time t₁₁, time t₁₂, time t₁₃, and time t₁₄, which are the timings for performing “search,” are predetermined timings decided on in the algorithm 231. The timing at which “search” is performed may be irregular, as in the present example, or may be a regular timing.

The algorithm 231 will be described with reference back to FIG. 5. The algorithm 231 is specifically a machine learning algorithm. More specifically, the algorithm 231 may be a multi-armed bandit (MAB) algorithm or the like. That is, the calculation unit 212 may be trained using the MAB algorithm.

By using the MAB algorithm, the transmission device 20 can reliably transmit information to the reception device 30 with small power consumption.

### [MAB Algorithm]

Hereinafter, the MAB algorithm will be described. The MAB algorithm is an algorithm used to solve the problem of maximizing the reward within a limited number of trials when there are multiple slot machines where the probability of getting a reward is not clear. In order to decide on a suitable communication parameter PM using this MAB algorithm, an amount of reward must be set in consideration of the trade-off between the power consumption required for transmission and whether or not the reception device 30 has correctly received information.

The transmission device 20 acquires an amount of power required for communication in a predetermined method. The transmission device 20, for example, may include a power measurement device (not shown) to measure actual power consumption. Also, the transmission device 20 may store a power consumption correspondence table (not shown) in which the communication parameter PM and the power consumption estimation amount are associated and acquire the amount of power with reference to the power consumption correspondence table.

Because it is more preferable to have less power consumption, it is desirable to decrease the amount of reward as the power consumption increases. By decreasing the amount of reward as the power consumption increases, it is possible to suppress an amount of power required for transmission by deciding on the communication parameter PM to reduce the power consumption in the algorithm 231, which is a MAB algorithm. Because it is indicated that information can be transmitted with high quality (i.e., reliably) as the deterioration rate D decreases, it is desirable to increase the amount of reward as the deterioration rate D decreases.

In the algorithm 231, communication history information IH is constructed using the calculated deterioration rate D. For example, the communication history information IH may be time-series data with a deterioration rate D. In the algorithm 231, a suitable communication parameter PM is decided on the basis of the communication history information IH, which is time-series data of the deterioration rate D.

In addition, the communication history information IH may be a single value calculated on the basis of the deterioration rate D accumulated in the past.

As another example, instead of an example in which the communication history information IH is held in the transmission device 20, the communication history information IH may be acquired from another device. The other device may be, for example, the reception device 30. That is, in another example, the reception device 30 holds the communication history information IH instead of the transmission device 20. In this case, the reception device 30 may count the number of times information could be received from the transmission device 20 without missing information and estimate the deterioration rate on the basis of the counted number of times. In this case, the reception device 30 transmits the communication history information IH to the transmission device 20 at a predetermined timing.

In the communication history information IH shown in FIG. 5, the time is the most recent information as the value increases. That is, when the value of time 1, time 2, time 3, . . . , or time N is larger, the information is more recent. In the case of the example shown in FIG. 5, because the deterioration rate D was sufficiently small at time 1 and time 2, a trial is performed (i.e., a search is performed) by changing the communication parameter PM at time 3 in the algorithm 231. The communication history information IH is added and updated (i.e., accumulated) every time a new communication parameter PM is applied. In the algorithm 231, the guideline information 232 is updated on the basis of the accumulated communication history information 233.

The guideline information 232 includes information required to determine how to set the communication parameter PM. In the algorithm 231, the communication parameter PM is decided on the basis of the updated guideline information 232 and communication is performed using the decided communication parameter PM.

In the algorithm 231, the communication history of the transmission device 20 is learned on the basis of the communication history information IH and the guideline information 232 for deciding on the communication parameter PM is updated. For “learning” and “guideline update,” the MAB algorithm described above is used. The “guideline update” may be performed every time the transmission device 20 transmits information, i.e., every time the communication history information IH is updated, or may be performed after a predetermined amount of communication history information IH is accumulated.

Also, when the communication parameter PM has a plurality of parameters as its components and the parameters include discrete values, it is possible to select one from all possible combinations capable of being taken by the communication parameter PM in the algorithm 231. That is, the communication parameter PM is calculated by selecting one combination from among the combinations of a plurality of components included in the communication parameter PM in the algorithm 231.

Specifically, a case where the communication parameter PM has component x, component y, and component z will be described. For example, if the component x is a ternary value of x1, x2, and x3, the component y is a binary value of y1 and y2, and the component z is a ternary value of z1, z2, and z3, it is possible to decide on the communication parameter PM by selecting one of 18 (3×2×3) combinations in the algorithm. According to a configuration in this way, it is possible to easily and optimally select a communication parameter PM composed of a plurality of elements in the algorithm 231.

Here, the algorithm 231 can use an upper confidence bound (UCB)1 algorithm when it is a combination of communication parameters PM that is somewhat complex. In this case, the calculation unit 212 is trained using the UCB1 algorithm.

Also, the algorithm 231 can use a lighter tug of war (TOW) algorithm when it is necessary to perform an operation with a microcontroller with low specifications. In this case, the calculation unit 212 is trained using a TOW algorithm.

In addition, the UCB1 algorithm herein includes a UCB1 algorithm and a UCB1-tuned algorithm.

### [Communication Parameters]

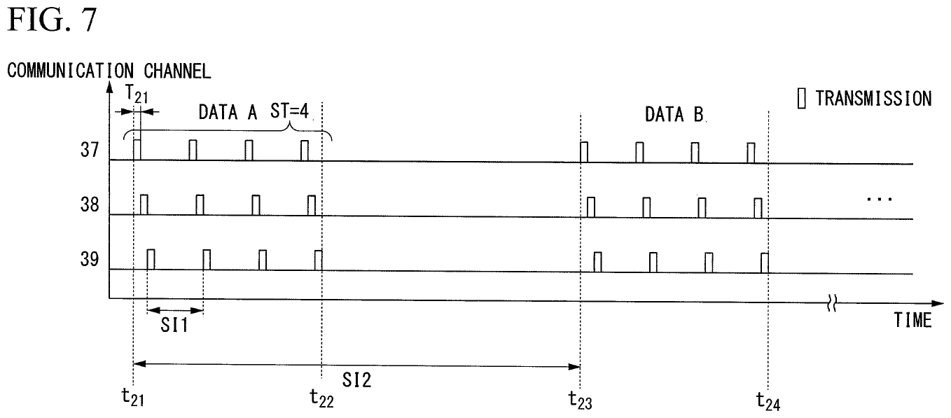

FIG. 7 is a timing chart showing an example of a timing of data transmission of the transmission device according to the embodiment. Specific components of the communication parameters PM will be described with reference to FIG. 7. In this example, the communication parameter PM has “communication channel,” “first transmission interval SI1,” “second transmission interval SI2,” “transmission count ST,” and “transmission power” as the components thereof. In the example shown in FIG. 7, three channels of 37ch (2402 MHz), 38ch (2426 MHz), and 39ch (2480 MHz), which are advertising channels used for advertising BLE, are used as “communication channel.” In FIG. 7, the horizontal axis is shown as a time axis with respect to a change in data to be transmitted on each channel over time.

During a period from time t₂₁ to time t₂₂, the wireless communication unit 22 sequentially outputs data A to each of the 37ch, 38ch, and 39ch. Period T₂₁ is a period required for transmitting data A.

Specifically, the wireless communication unit 22 outputs data A to 37ch at time t₂₁, subsequently outputs data A to 38ch, and subsequently outputs data A to 39ch. After outputting data A to each channel, the wireless communication unit 22 outputs data A to each channel again at the first transmission interval SI1. This is iterated until the predetermined transmission count ST is reached. According to an example shown in FIG. 7, because the transmission count ST is 4, the same data is output four times per channel.

That is, the communication parameter PM includes the first transmission interval SI1, and the wireless communication unit 22 transmits a signal to the reception device 30 on the basis of the first transmission interval SI1.

Here, the first transmission interval SI1 is an interval at which the same data is transmitted to each channel. According to BLE, the advertisement process is a process that is performed for each of the plurality of advertising channels. For example, the advertisement process is separately performed for three advertising channels of 37ch, 38ch, and 39ch. Here, each channel may interfere with other radio waves present in space. When interference has occurred on all three channels or when the reception device 30 is not ready for reception, a situation in which the information transmitted by the transmission device 20 does not reach the reception device 30 occurs. In preparation for such a situation, a packet obtained by encoding the same data is regularly transmitted multiple times.

Also, a case where the reception device is not ready for reception is a case where a reception operation is performed intermittently to reduce power consumption at the BLE reception side (the central device) or the like.

The wireless communication unit 22 begins to output data A at time t₂₁ and then begins to output data B different from data A after the elapse of the second transmission interval SI2. That is, during a period from time t₂₃ to time t₂₄, the wireless communication unit 22 outputs data B to 37ch, 38ch, and 39ch. The second transmission interval SI2 is an interval until the data is updated and newly transmitted.

Here, the wireless communication unit 22 completes the information transmission process for the reception device 30 during a transmission time period, which is a period of time from the start of signal generation to the end of transmission.

The calculation unit 212 may adjust the communication parameter PM so that the transmission time period is reduced when the reception device 30 has continuously and stably received the information transmitted by the wireless communication unit 22. In this case, the calculation unit 212 may adjust the communication parameter PM so that the transmission time period is reduced on the basis of information included in the reception information IR received from the reception device 30.

In addition, when the reception device 30 has continuously and stably received the information transmitted by the wireless communication unit 22, the determination may be made by the reception device 30 or the transmission device 20. When the determination is made by the transmission device 20, the determination may be made on the basis of whether or not there is reception information IR that is a response to the transmission information IS.

Also, the wireless communication unit 22 iteratively performs a transmission process during a period from the time of system activation to an assumed operating lifespan. The system may be, for example, a system that operates the transmission device 20, and the time of activation of the system may be the time when the transmission device 20 was powered on. The time when the transmission device 20 was powered on may be the time when the power was first turned on before factory shipments or may be the time when the power was first turned on after factory shipments.

In this case, the calculation unit 212 adjusts the communication parameter PM to reduce a total time period required for the information transmission process when the reception device 30 has continuously and stably received the information transmitted by the wireless communication unit 22. The calculation unit 212 may adjust the communication parameter PM to reduce the total time period required for the information transmission process on the basis of the information included in the reception information IR received from the reception device 30.

Also, the wireless communication unit 22 transmits first data (data A) obtained by encoding the same data until a certain transmission count ST is reached on the basis of the first transmission interval SI1 and then transmits second data (data B) different from the first data on the basis of the second transmission interval SI2. Further, third, fourth, . . . , n^{th} data (n is a natural number of 1 or more) that are different from each other may be transmitted on the basis of the second transmission interval SI2 that is continuous.

In this case, the communication parameters PM include the second transmission interval SI2 and the transmission count ST.

Also, the calculation unit 212 adjusts the communication parameter PM to reduce the transmission count ST when the reception device 30 has continuously and stably received the information transmitted by the wireless communication unit 22. The calculation unit 212 may adjust the communication parameter PM to reduce the transmission count ST on the basis of information included in the reception information IR received from the reception device 30.

When the communication parameters PM include the second transmission interval SI2 and when the reception device 30 has continuously and stably received the information transmitted by the wireless communication unit 22, the communication parameter PM may be adjusted to increase the second transmission interval SI2. Also, the calculation unit 212 may adjust the communication parameter PM to increase the second transmission interval SI2 when the information transmitted by the wireless communication unit 22 has not been continuously received by the reception device 30. Also, when the communication environment is improved and data can be stably received, the second transmission interval SI2 may be reduced or returned to the original value. By decreasing the second transmission interval SI2 or returning the second transmission interval SI2 to the original value, a period of time until the connection with the reception device 30 is made can be shortened, and the connection can be stably made.

Also, the second transmission interval SI2 may be reduced when data with high urgency is transmitted. Thereby, it is possible to suppress power consumption when normal data is transmitted and transmit data to the reception device 30 without delay when data with high urgency is transmitted.

### [Channel Mask]

Next, a channel mask that is an example of the communication parameter PM will be described. The channel mask is a communication parameter for determining the channel to be used when a communication method in which a plurality of channels are defined in a used band is used. When a communication method in which a plurality of channels are defined in the used band is used, a channel mask for determining the channel to be used may be included as the communication parameter PM.

In other words, the channel designated by the channel mask may be a channel that is not used for communication. Specifically, when the communication method in the present embodiment is advertising defined in the BLE standard, the communication channel may be an advertising channel defined in the BLE standard. Advertising may be connectable advertising. The deterioration rate D may be a value calculated on the basis of whether or not the connection request has been answered.

The calculation unit 212 decides on the communication parameter PM so that the deterioration rate D is reduced when communication with the reception device 30 of the specific other party is performed via a channel mask included in the calculated communication parameter PM.

For example, the BLE advertisement process is separately performed for three advertising channels 37, 38, and 39. At this time, the advertisement process is performed through channels 37 and 39 if channel 38 is masked and the advertisement process is performed through channel 37 if channels 38 and 39 are masked. At this time, of course, power required for transmission can be reduced as the number of used channels decreases. However, there is a trade-off relationship in which a probability of non-transmission of information due to interference increases.

If the environment in which the transmission device 20 is located is a communication environment with little interference, the number of channels to be used should be minimized by the channel mask and limited to the number of channels with the least probability of interference. Also, if the environment in which the transmission device 20 is located is a communication environment with a lot of interference, a large number of channels to be used should be used even at the expense of power consumption. Although the transmission device 20 cannot know the situation of the communication environment in advance, it is possible to select a suitable channel mask for adapting to the communication environment in which it is located and transmitting information with small power consumption according to “utilization” and “search” for the channel mask.

Here, as a simplified procedure, it is preferable to adjust the channel mask so that the number of channels for use in information communication increases when the deterioration rate D has increased. Also, when the deterioration rate D is regarded as sufficiently small, it is preferable to reduce power consumption by reducing the number of channels for use in communication. These are contradictory and it is preferable to appropriately update the channel mask in consideration of the trade-off between reliable transmission of information and power consumption in the algorithm 231.

As an example, the advertisement may accept a scan request. In this case, the central device, which has received the advertising packet, can transmit the scan request, and the deterioration rate D is calculated on the basis of whether or not the scan request has been answered. Also, when the transmission device 20 communicates with a plurality of reception devices 30, the deterioration rate D may be calculated on the basis of the number of advertising packets received by one or more specific reception devices 30.

### [Transmission Time Interval and Transmission Count]

Next, the first transmission interval SI1, the transmission count ST, and the second transmission interval SI2, which are examples of the communication parameter PM, will be described more specifically.

The first transmission interval SI1 is a time interval for transmitting the same data. This reduces the probability of interference by distributing the transmission of information (making the transmission of information redundant) in time. However, it is not practical to simply define the procedure for the deterioration rate and it is desirable to increase the time interval, for example, when continuous interference occurs during a relatively long period of time. On the other hand, when interference occurs frequently in bursts (in the form of condensation in a short time), it is desirable to shorten the time interval. Because it is difficult to estimate in advance a degree of interference dependent on the time of such a communication environment, the transmission device 20 derives a suitable communication parameter PM using “utilization” and “search.”

It is desirable to increase the transmission count ST when the deterioration rate D increases and to decrease the transmission count ST when the deterioration rate D is regarded as sufficiently small. This is to reduce the required power by reducing the transmission count ST.

When the first transmission interval SI1 and the transmission count ST are considered together, it is desirable to reduce a time period required to complete the transmission of the same data (a required transmission time period, for example, the product of the first transmission interval SI1 and the transmission count ST) in power reduction. This is because a control unit (a microcontroller, an integrated circuit, or another electronic circuit) (not shown) needs to continue an operation for the next transmission process during the required transmission time period and power is consumed as the required transmission time period increases.

Therefore, it is desirable to increase the required transmission time period when the deterioration rate D increases and to decrease the required transmission time period when the deterioration rate D is regarded as sufficiently small. Because the required transmission time period is defined by the first transmission interval SI1 and the transmission count ST, these values are independently adjusted in the algorithm 231.

The calculation unit 212 may adjust the communication parameter PM to reduce the first transmission interval SI1 when the reception device 30 has continuously and stably received the information transmitted by the wireless communication unit 22.

The second transmission interval SI2 is an interval for newly transmitting updated information. For example, when an information update frequency is not high, it is desirable to increase the second transmission interval SI2 when the deterioration rate D is regarded as sufficiently small. The second transmission interval SI2 also affects power consumption in a period from the start of operation of the device to the end of operation.

When it is estimated that the reception device 30, which is an information transmission target device, is not located within a communication range of the transmission device 20, it is desirable to increase the second transmission interval SI2 in order to prevent unnecessary information transmission from being frequently performed. This is, for example, the time when there is no communication even if all channels are used and the transmission power is sufficiently large or the like. In the case where the reception device 30 that is the other party of communication is restored, the number of channels and the transmission power should be maintained as they are, but the frequency of existence confirmation should be reduced.

The above-described time elements (the first transmission interval SI1, the transmission count ST, and the second transmission interval SI2) do not necessarily need to be used with values that exactly match numerical values decided on in the algorithm 231. For example, the numerical value decided on in the algorithm 231 may have a width of a certain extent and may be used as a communication interval. That is, the first transmission interval SI1, the transmission count ST, and the second transmission interval SI2 may be time intervals based on random values. For example, a time interval based on a random value may be implemented by adding a random value to the decided numerical value or subtracting a random value from the decided numerical value.

A method using a time interval based on a random value is useful for preventing mutual interference due to mutual matching of intervals when two or more devices use the method of the communication system 1. For example, when the transmission interval of device A is 400 [milliseconds (ms)] and the transmission interval of device B is also 400 [ms], interference may continue because the timings match. Even in such a case, interference can be avoided if the time interval is decided on the basis of a random value.

### [Transmission Power]

When the transmission power is included in the communication parameter PM, it is desirable to increase the strength of the radio waves when the deterioration rate D increases and to decrease the strength of the radio waves when the deterioration rate D is regarded as sufficiently small. This is to reduce the required power by adjusting the strength of radio waves by adapting to the communication environment.

Although a component provided in the transmission device 20 has been described as the communication parameter PM, the component provided in the reception device 30 may be used as a communication parameter. The component provided in the reception device 30 may be, for example, an ON duty ratio of the communication unit of the reception device 30, the number of stages of a multistage amplifier, a response speed of the response to the received packet, or the like.

### [Modified Example of Communication History Information]

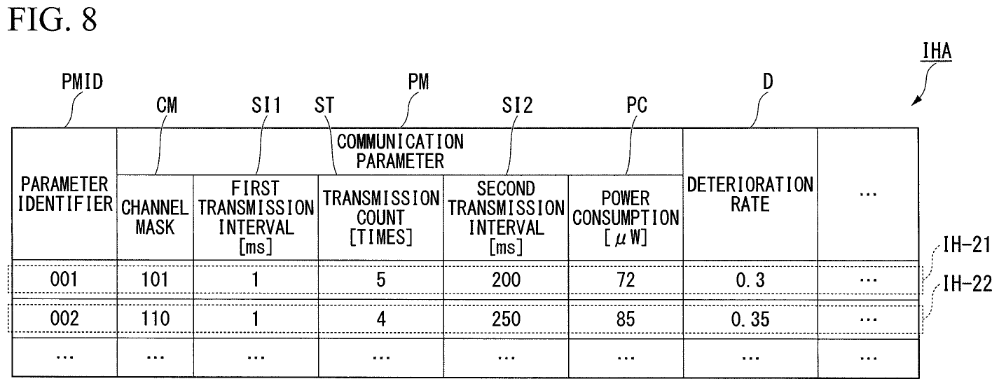

FIG. 8 is a diagram showing a modified example of the communication history information according to the embodiment. The communication history information IHA will be described with reference to FIG. 8. The communication history information IHA is a modified example of the communication history information IH. Components similar to those of the communication history information IH are denoted by similar reference signs and description thereof may be omitted. The communication history information IHA further includes a parameter identifier PMID and has a channel mask CM, a first transmission interval SI1, a transmission count ST, a second transmission interval SI2, and power consumption PC as the communication parameter PM unlike the communication history information IH.

The communication history information IHA is stored in the communication history information storage unit 211 and the calculation unit 212 calculates the communication parameter PM on the basis of the communication history information IHA stored in the communication history information storage unit 211. The power consumption PC is power consumption generated by transmitting radio waves using the communication parameter PM included in the communication history information IHA. The deterioration rate D of the case where the communication parameter PM is used is associated with the communication history information IHA. That is, the calculation unit 212 calculates the communication parameter PM on the basis of the power consumption PC generated by transmitting radio waves using the communication parameter PM included in the communication history information IHA and the corresponding deterioration rate D. More specifically, the calculation unit 212 calculates the communication parameter PM to reduce the power consumption PC.

Because the communication history information IHA has a channel mask CM, a first transmission interval SI1, a transmission count ST, a second transmission interval SI2, and a power consumption PC as the communication parameter PM, the transmission device 20 can perform communication using a suitable communication parameter PM in consideration of the trade-off between communication reliability and power consumption with higher accuracy.

Here, because the communication history information IHA has a parameter identifier PMID, all combinations of values that can be taken by each communication parameter PM can be examined without omission. Also, because the communication history information IHA has a parameter identifier PMID, the algorithm 231 can easily find a suitable parameter.

[Example of Case where Parameter Identifier is Used]

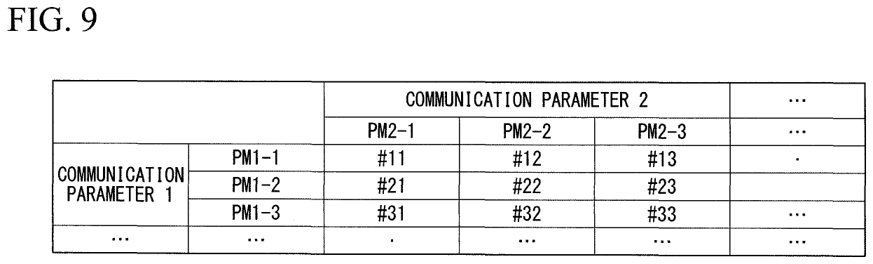

FIG. 9 is a diagram for describing an example in which the parameter identifier is used according to the embodiment. The parameter identifier PMID will be described with reference to FIG. 9. In the description in FIG. 9, an example in which a communication parameter PM1 and a communication parameter PM2 are provided as the communication parameter PM will be described.

The communication parameter PM1 can take “PM1-1,” “PM1-2,” and “PM1-3” as discrete values. The communication parameter PM2 can take “PM2-1,” “PM2-2,” and “PM2-3” as discrete values. In this case, because there are nine types of combinations capable of being taken by the communication parameter PM, the parameter identifier PMID is of nine types of “#11,” “#12,” . . . , “#33.” In the algorithm 231, the communication parameter PM is identified using the parameter identifier PMID, so that the transmission device 20 and the reception device 30 can easily communicate the communication parameter PM to be used with each other.

Also, as another example, the communication parameter PM may include the strength of a radio signal in information communication to be performed with the reception device 30. The strength of the radio signal may be, for example, an RSSI.

In this case, the calculation unit 212 may adjust the communication parameter PM so that the strength is decreased when the reception device 30 has continuously and stably received the information transmitted by the wireless communication unit 22.

[Example in which Communication History Information is Weighted]

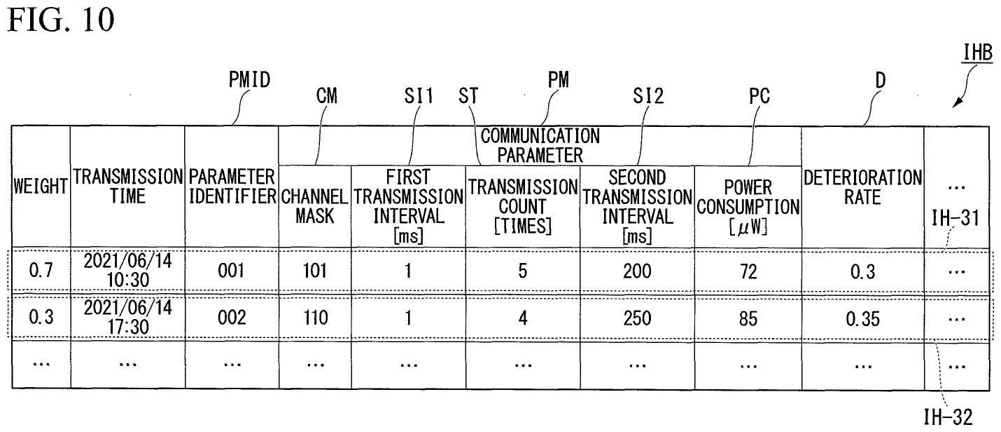

FIG. 10 is a diagram for describing an example in which the communication history information is weighted according to the embodiment. The communication history information IHB will be described with reference to FIG. 10. The communication history information IB is a modified example of a communication history information IHA. Components similar to those of the communication history information IHA are denoted by similar reference signs and description thereof may be omitted. The communication history information IHB is different from the communication history information IHA in that the weight and the transmission time are further associated.

The communication history information IHB is stored in the communication history information storage unit 211 and the calculation unit 212 calculates the communication parameter PM on the basis of the communication history information IHB stored in the communication history information storage unit 211.

The transmission time is the time at which communication is performed using the communication parameter PM or the time at which the deterioration rate D is obtained as a result of performing communication. That is, the communication history information storage unit 211 stores a plurality of communication history information items IH with different transmission times.

The weight is a value expressed as a percentage of the weight used in the algorithm 231 for calculation. For example, it is desirable to more strongly weight newer information indicating the recent communication environment. That is, the calculation unit 212 performs a calculation process by more strongly weighting the newer information among the plurality of communication history information items IH.

As an extreme example, when the latest communication history information IH is weighted by 100%, the value for use in the calculation in the algorithm 231 is equal to the deterioration rate D of the latest communication history information IH.

### [Guideline Information and Communication History Information]

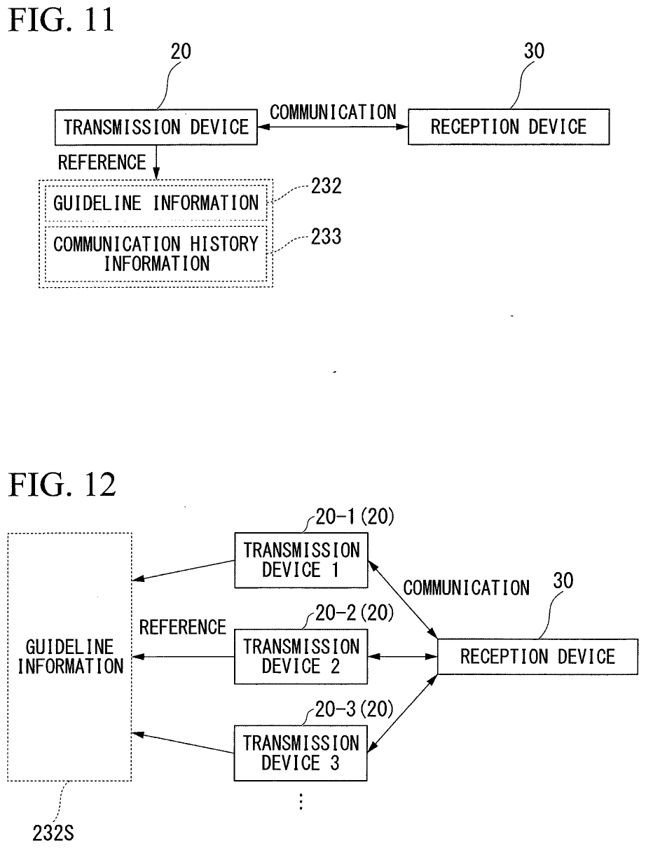

Next, relationships between the guideline information 232 and the communication history information 233 and the transmission device 20 will be described with reference to FIGS. 11 and 12.

FIG. 11 is a diagram for describing an example in which the guideline information is occupied by one transmission device according to the embodiment. An example in which the transmission device 20 and the reception device 30 performs information communication on a one-to-one basis will be described with reference to FIG. 11.

When the transmission device 20 and the reception device 30 performs information communication on a one-to-one basis, the plurality of transmission devices 20 perform information communication on the basis of their own guideline information 232. The guideline information 232 is derived in the algorithm 231 on the basis of the communication history information 233 accumulated as a result of performing information communication in each transmission device 20. That is, when the transmission device 20 and the reception device 30 communicate information on a one-to-one basis, the transmission device 20 has the guideline information 232 and communication history information 233 that are unique.

FIG. 12 is a diagram for describing an example in which the guideline information is shared by a plurality of transmission devices according to the embodiment. An example in which the transmission device 20 and the reception device 30 communicate information on a many-to-many basis will be described with reference to FIG. 12. A many-to-many information communication case may be, for example, a multi-hop communication device. Also, it may be a many-to-one communication system in which information communication is performed by a plurality of transmission devices 20 and one reception device 30.

A case where a plurality of transmission devices 20 and one reception device 30 perform information communication will be described with reference to FIG. 12. Specifically, an example in which the transmission device 20-1, the transmission device 20-2, and the transmission device 20-3 perform information communication with the reception device 30 will be described. The transmission device 20-1, the transmission device 20-2, and the transmission device 20-3 perform information communication on the basis of guideline information 232S. The guideline information 232S is derived by the algorithm 231 on the basis of the communication history information 233 accumulated as results of performing information communication in the transmission device 20-1, the transmission device 20-2, and the transmission device 20-3. That is, when the plurality of transmission devices 20 and the reception device 30 perform information communication on a many-to-one basis or perform communication on a many-to-many basis, the plurality of transmission devices 20 perform information communication on the basis of one guideline information item 232.

When each transmission device 20 or a plurality of transmission devices 20 communicates with a plurality of reception devices 30, the calculation unit 212 provided in the transmission device 20 calculates the communication parameter PM on the basis of the plurality of communication history information items IH obtained as results of performing communication with the plurality of reception devices 30.

As another example, the transmission device 20 and the reception device 30 may share the communication history information IH. In this case, the reception device 30 includes a reception-side communication history information storage unit configured to store the communication history information IH in place of or in addition to the communication history information storage unit 211 provided in the transmission device 20, such that the transmission device 20 and the reception device 30 included in the communication system 1 share the communication history information IH.

Although an example in which the transmission device 20 and the reception device 30 perform information communication based on wireless communication has been described above, the present embodiment is not limited to an example of wireless communication. The transmission device 20 and the reception device 30 may perform information communication based on wired communication. When the transmission device 20 and the reception device 30 perform the information communication based on the wired communication, the channel may be included as a communication parameter if the communication interval, the transmission power, and the communication are multiplexed.

In this case, it is possible to transmit information with minimal power consumption while avoiding interference from other devices connected by the same line. An example of the wired communication may be an integral or many-to-many wired communication method such as a bus connection, a star connection, or a mesh connection. Specifically, it may be a communication method such as the Internet, an inter-integrated circuit (I2C), a serial peripheral interface (SPI), a controller area network (CAN), or the like.

### [Summary of Embodiment]

According to the above-described embodiment, the transmission device 20 includes the communication history information storage unit 211 to store the communication parameter PM and the deterioration rate D as the communication history information IH in association, includes the calculation unit 212 to calculate the communication parameter PM when communication with the reception device 30 is performed on the basis of the stored communication history information IH, and includes the output unit 213 to perform information communication with the reception device 30 on the basis of the calculated communication parameter PM. Therefore, according to the transmission device 20, because information communication can be performed on the basis of a suitable communication parameter PM calculated on the basis of the accumulated communication history information IH, it is possible to suppress power consumption while maintaining reliability.

Also, according to the above-described embodiment, the calculation unit 212 is trained on the basis of the deterioration rate D obtained as a result of performing information communication using the communication parameter PM output by the output unit 213 using a machine learning algorithm. Therefore, the transmission device 20 includes the calculation unit 212 to iterate the utilization and search without simply selecting communication parameters. Therefore, according to the transmission device 20, it is possible to maintain reliability and perform information communication while suppressing power consumption even if the surrounding environment in which the transmission device 20 is placed changes by iterating the utilization and search.

Also, according to the above-described embodiment, the calculation unit 212 is trained using a multi-armed bandit (MAB) algorithm. Therefore, the transmission device 20 can reduce the weight and size of a device and extend the lifespan of a device.

Also, according to the above-described embodiment, the calculation unit 212 calculates the communication parameter PM on the basis of the power consumption PC caused by transmitting radio waves using the communication parameter PM and the deterioration rate D corresponding thereto. The calculation unit 212 calculates a suitable communication parameter PM on the basis of the deterioration rate D. Therefore, the calculation unit 212 does not select the communication parameter PM having an excessive margin. Consequently, according to the transmission device 20, a trade-off between the reliability of information transmission and the power consumption PC can be valid.

Also, according to the above-described embodiment, the calculation unit 212 calculates the communication parameter PM for reducing the power consumption PC. Therefore, according to the transmission device 20, the power consumption required for information communication can be suppressed and suitable parameters can be decided on for transmitting information.

Also, according to the above-described embodiment, the calculation unit 212 is trained using the UCB1 algorithm. Therefore, according to the transmission device 20, learning can be performed even if the combination of communication parameters PM is somewhat complex.

Also, according to the above-described embodiment, the calculation unit 212 is trained using a lightweight TOW algorithm. Therefore, according to the transmission device 20, the algorithm 231 can be operated even if a microcomputer or the like has low specifications.

Also, according to the above-described embodiment, the calculation unit 212 calculates the communication parameter PM on the basis of a plurality of communication history information items UH obtained as a result of communicating with a plurality of reception devices 30. By considering the deterioration rate D communicated between two or more reception devices 30, the transmission device 20 can perform information communication using a communication parameter PM for stably delivering information to the reception device 30 that is a communication partner.

Also, according to the above-described embodiment, the deterioration rate D is binary. Therefore, the transmission device 20 can simplify a process of calculating the deterioration rate D and deciding on the communication parameter PM.

Also, according to the above-described embodiment, the deterioration rate D indicates whether or not the information communication performed between the transmission device 20 and the reception device 30 has succeeded. Therefore, the transmission device 20 can decide on the communication parameter in simple calculation.

Also, according to the above-described embodiment, the deterioration rate D is based on information about the strength of radio waves included in radio waves received from the reception device 30. Information about the strength of radio waves is, for example, an RSSI. Therefore, according to the transmission device 20, the deterioration rate D can be treated to be multivalued. Because the deterioration rate D can be treated to be multivalued, the transmission device 20 can decide on the communication parameter PM on the basis of more determination materials. For example, when there is a possibility that communication will not be valid because the radio wave strength is somewhat weak, the transmission device 20 can perform a process with a “degree” to which information is stably delivered or the like by setting the communication parameter PM to slightly strengthen the communication strength.

Also, according to the above-described embodiment, the transmission device 20 transmits a signal encoded in an encoding scheme having an error detection function to the reception device 30 on the basis of the communication parameter PM. Also, the deterioration rate D is based on an error rate when the signal received from the reception device 30 has been decoded. In other words, according to the transmission device 20, the error rate of the received signal is used in the deterioration rate D. Consequently, according to the transmission device 20, a state in which the packet is damaged can be used as a determination material. In addition, the state in which the packet is damaged may have a binary value indicating whether or not the packet has been damaged or may have a multi-value indicating a degree of damage.

Also, according to the above-described embodiment, the communication history information storage unit 211 stores a plurality of communication history information items IH and the calculation unit 212 performs a calculation process by more strongly weighting newer information among the plurality of communication history information items UH. Therefore, according to the transmission device 20, even when the environment changes, communication using a suitable communication parameter PM can be performed quickly and in accordance with the new environment. Consequently, according to the transmission device 20, information communication in which reliability is maintained can be performed.

Also, according to the above-described embodiment, the communication history information IH is associated with a parameter identifier PMID for identifying the communication parameter PM. The calculation unit 212 decides on the communication parameter PM on the basis of the accumulated communication parameters PM and a result of performing information communication using the communication parameters PM. According to the present embodiment, because the communication history information IH is managed in association with the parameter identifier PMID, the communication parameter PM can be easily identified. For example, the transmission device 20 transmits the parameter identifier PMID to the reception device 30, such that the communication parameter PM used for information communication can be identified on the reception device 30 side. Therefore, the progress of the search can be ascertained in a device other than the transmission device 20 and the guideline information can be updated in a device other than the transmission device 20.

Also, according to the above-described embodiment, the communication parameter PM includes a plurality of components. In this case, the calculation unit 212 calculates the communication parameter PM by selecting one combination among the combinations of a plurality of components included in the communication parameter PM. Therefore, according to the transmission device 20, even if the communication parameter PM includes a plurality of elements, an algorithm can be simplified to select one of a plurality of combinations and the algorithm 231 can be lightened.

Also, according to the above-described embodiment, the information communication performed between the transmission device 20 and the reception device 30 is a communication method in which a plurality of communication channels are defined in a predetermined frequency band. Also, the communication parameter PM includes a channel mask CM. The channel mask CM is used to identify one or more channels that are included in the communication channels and are not used for information communication between the transmission device 20 and the reception device 30. Therefore, according to the transmission device 20, because a communication channel is included as the communication parameter PM, an unnecessary channel for information transmission cannot be used. For example, when interference always occurs in a particular channel, it is possible to suppress unnecessary power consumption while maintaining the reliability of communication by masking the channel.

Here, when the information communication performed between the transmission device 20 and the reception device 30 is wireless communication conforming to the BLE standard, a radio signal may be transmitted via three channels that are advertising channels. At this time, wireless transmission, which does not contribute to information transmission, such as (1) a case where ineffective wireless transmission may be performed when the reception device 30 is not located outside of a transmission range, (2) a case where interference may frequently occur on some channels due to interference with devices in the vicinity of the transmission device 20, and communication via the channel is ineffective, or (3) a case where transmission is performed more times or for a longer time than necessary due to a reason such as the short distance between the communication devices 10 even though the information is reliably received may occur and power for that purpose may be consumed. When the transmission device 20 is driven by a battery, the unnecessary power consumption is directly related to shortening the battery lifespan. Therefore, there is a desire to suppress unnecessary power consumption.

According to the present embodiment, because unnecessary power consumption can be suppressed by masking unnecessary channels, the battery lifespan can be extended.

Also, according to the above-described embodiment, it is indicated that radio waves transmitted to the reception device 30 do not deteriorate as the deterioration rate D decreases. The calculation unit 212 decides on the communication parameter PM so that the deterioration rate D decreases when communication with the reception device 30, which is a specific other party, is performed via the channel mask CM included in the calculated communication parameter PM. Therefore, the transmission device 20 can derive a suitable communication parameter PM for transmitting information to the other party by selecting the channel mask CM to reduce the deterioration rate D.

Also, according to the above-described embodiment, the information communication performed between the transmission device 20 and the reception device 30 is wireless communication conforming to the BLE standard. Because power consumption is small in BLE, the transmission device 20 can suppress power consumption by performing wireless communication conforming to BLE. Also, the transmission device 20 can perform information communication with the reception device 30 conforming to BLE by performing wireless communication conforming to BLE.

Also, according to the above-described embodiment, information communication performed between the transmission device 20 and the reception device 30 is advertising as defined in the BLE standard. The communication channel is an advertising channel defined in the BLE standard. According to the transmission device 20, the advertising channel is masked, such that the BLE advertising packet can be transmitted to the reception device 30 (central device) located in a surrounding area with the minimum necessary power consumption.

Also, according to the above-described embodiment, the advertising is connectable advertising. Also, the deterioration rate D is a value calculated on the basis of whether or not a connection request has been returned. That is, the transmission device 20 determines that the packet has arrived when the connection request has been returned from the reception device 30. Therefore, according to the transmission device 20, the deterioration rate D can be easily calculated.

Also, according to the above-described embodiment, the advertising is advertising for receiving a scan request. In this case, the deterioration rate D is calculated on the basis of whether or not the scan request has been answered. That is, the transmission device 20 determines that the packet has arrived when the scan request has been returned from the reception device 30. Therefore, according to the transmission device 20, the deterioration rate D can be easily calculated.

Also, according to the above-described embodiment, the deterioration rate D is calculated on the basis of the number of times one or more specific reception devices 30 have received an advertising packet. Specifically, the reception device 30 counts the number of packets received from the transmission device 20 and feeds back the counted number of packets to the transmission device 20. The transmission device 20 collectively updates the guideline information on the basis of the number of packets that has been fed back. Therefore, the scale of the transmission device 20 can be reduced when the reception device 30 is responsible for a part of the calculation process for the deterioration rate D. Therefore, according to the present embodiment, the transmission device 20 can be miniaturized. Also, according to the present embodiment, because the reception device 30 is responsible for a part of the calculation process for the deterioration rate D, the power consumption of the transmission device 20 can be suppressed, i.e., the lifespan of the transmission device 20 can be extended.

Also, according to the above-described embodiment, the transmission device 20 includes the wireless communication unit 22 to perform information communication with the reception device 30 on the basis of the communication parameter PM. Here, the communication parameter PM includes the first transmission interval SI1. The wireless communication unit 22 transmits a signal to the reception device 30 on the basis of the first transmission interval SI1. Therefore, the transmission device 20 controls a density of transmission signals by controlling the first transmission interval SI1. The transmission device 20 controls the density of transmission signals, thereby avoiding interference with radio waves transmitted by the other communication device 10.

Also, according to the above-described embodiment, the wireless communication unit 22 completes an information transmission process for the reception device during a transmission time period. The transmission time period is a time period from a start of signal generation to an end of transmission. Also, the calculation unit 212 adjusts the communication parameter PM so that the transmission time period is decreased when the reception device 30 has continuously and stably received information transmitted by the wireless communication unit 22. According to the present embodiment, excess power can be prevented from being consumed by reducing the transmission time when the information has stably reached the reception device 30.

Also, according to the above-described embodiment, the wireless communication unit 22 performs a transmission process that is iterated during a period from the time of system activation to an assumed operating lifespan. When the reception device 30 has continuously and stably received the information transmitted by the wireless communication unit 22, the calculation unit 212 adjusts the communication parameter PM to reduce the total time period required for the information transmission process. Therefore, according to the present embodiment, when the information has been stably reached, it is possible to reduce the transmission time period and to prevent unnecessary power consumption.

Also, according to the above-described embodiment, the communication parameter PM includes the second transmission interval SI2 and the transmission count ST. The wireless communication unit 22 transmits first data obtained by encoding the same data until a specific transmission count ST is reached on the basis of the first transmission interval SI1. After the first data is transmitted, the wireless communication unit 22 transmits second data different from the first data on the basis of the second transmission interval SI2. That is, the transmission device 20 includes each time element required for communication in the communication parameter PM. The transmission device 20 can control the transmission density and avoid the interference using the communication parameter PM including each time element. Further, the transmission device 20 can suppress power consumption.

Also, according to the above-described embodiment, the calculation unit 212 adjusts the communication parameter PM so that the transmission count ST is decreased when the reception device 30 has continuously and stably received information transmitted by the wireless communication unit 22. Therefore, the transmission device 20 can suppress unnecessary signal transmission by reducing the transmission count ST.

Also, according to the above-described embodiment, the calculation unit 212 adjusts the communication parameter PM so that the second transmission interval SI2 is increased when the reception device 30 has continuously and stably received information transmitted by the wireless communication unit 22. By increasing the second transmission interval SI2, the signal transmission interval is lengthened, so that excess signal transmission can be suppressed. That is, power consumption can be suppressed.

Also, according to the above-described embodiment, the calculation unit 212 adjusts the communication parameter PM so that the second transmission interval SI2 is increased when the reception device 30 has not continuously received information transmitted by the wireless communication unit 22. Here, when the signal transmitted by the transmission device 20 has not been continuously received by the reception device 30 (i.e., when there is no communication), there is a possibility that the reception device 30 of the communication partner will not be present. Therefore, when there is a possibility that the communication partner will not be present, the transmission device 20 can increase the second transmission interval SI2 by increasing the second transmission interval SI2 and suppress unnecessary signal transmission. That is, according to the present embodiment, the transmission device 20 can suppress unnecessary power consumption.

Also, according to the above-described embodiment, the calculation unit 212 adjusts the communication parameter PM so that the first transmission interval SI1 is decreased when the reception device 30 has continuously and stably received information transmitted by the wireless communication unit 22. Therefore, according to the present embodiment, the transmission device 20 can suppress unnecessary power consumption.

Also, according to the above-described embodiment, the second transmission interval SI2 is a time interval based on a random value. In other words, the wireless communication unit 22 uses a value in which the second transmission interval SI2 decided on in the algorithm 231 has a random time fluctuation. The wireless communication unit 22 uses the second transmission interval SI2 with a random time fluctuation, such that the transmission intervals of the plurality of transmission devices 20 are completely matched and interference can be avoided for a long time.

Also, according to the above-described embodiment, the first transmission interval SI1 is a time interval based on a random value. In other words, the wireless communication unit 22 uses a value in which the first transmission interval SI1 decided on in the algorithm 231 has a random time fluctuation. The wireless communication unit 22 uses the first transmission interval SI1 with the random time fluctuation, such that the transmission intervals of the plurality of transmission devices 20 are completely matched and interference can be avoided for a long time.

Also, according to the above-described embodiment, the communication parameter PM includes the strength of a radio signal in information communication performed between the transmission device 20 and the reception device 30. Because the transmission device 20 includes the strength of the radio signal in the communication parameter PM, information can be transmitted with appropriate power consumption according to the transmission distance.

Also, according to the above-described embodiment, the calculation unit 212 adjusts the communication parameter PM so that the strength of the radio signal is decreased when the reception device 30 has continuously and stably received information transmitted by the wireless communication unit 22. The transmission device 20 can prevent unnecessary power consumption by adjusting the communication parameter PM to reduce the strength of the radio signal.

Also, according to the above-described embodiment, the communication system 1 includes the transmission device 20 and the reception device 30 that performs information communication with the transmission device 20. The reception device 30 includes a reception-side communication history information storage unit configured to store the communication history information IH. The communication history information IH is shared between the reception device 30 and the transmission device 20. In this case, the reception device 30 updates the guideline information and feeds back the updated guideline information to the reception device 30 at an appropriate timing. Therefore, according to the communication system 1, the transmission device 20 does not need to store the communication history information IH and the transmission device 20 can be further miniaturized and extended in lifespan.

All or some functions provided in the devices provided in the communication system 1 according to the above-described embodiment and the parts provided in the devices are implemented by recording a program for implementing these functions on a computer-readable recording medium and causing a computer system to read and execute the program recorded on the recording medium. Also, the “computer system” used herein is assumed to include an operating system (OS) and hardware such as peripheral equipment.

Also, the “computer-readable recording medium” refers to a flexible disk, a magneto-optical disc, a read-only memory (ROM), a portable medium such as a compact disc (CD)-ROM, or a storage device such as a hard disk embedded in the computer system. Furthermore, the “computer-readable recording medium” may include a computer-readable recording medium for dynamically holding the program for a short time period as in a communication line when the program is transmitted via a network such as the Internet or a communication circuit such as a telephone circuit and a computer-readable recording medium for holding the program for a given time period as in a volatile memory inside the computer system serving as a server or a client when the program is transmitted. Also, the above-described program may be a program for implementing some of the above-described functions. Furthermore, the above-described program may be a program capable of implementing the above-described function in combination with a program already recorded on the computer system.

Although embodiments of the present invention have been described above, the present invention is not limited to the embodiments and various modifications can also be made without departing from the scope and spirit of the present invention.

### INDUSTRIAL APPLICABILITY

According to the present invention, it is possible to provide communication technology for suppressing power consumption while maintaining reliability.

1. A transmission device for performing information communication with one or more reception devices, the transmission device comprising:
a communication history information storage unit configured to store communication history information in which a communication parameter for performing the information communication is associated with a deterioration rate that is a value based on radio waves transmitted using the communication parameter when information is transmitted to the reception device and radio waves received from the reception device;
a calculation unit configured to calculate the communication parameter when communication with the reception device is performed on the basis of the stored communication history information; and
an output unit configured to output the calculated communication parameter.

2. The transmission device according to claim 1, wherein the calculation unit is trained on the basis of the deterioration rate obtained from an information communication result using the communication parameter output by the output unit using a machine learning algorithm.

3. (canceled)

4. (canceled)

5. The transmission device according to claim 1, wherein the calculation unit calculates the communication parameter on the basis of power consumption caused by transmitting radio waves using the communication parameter included in the communication history information and the deterioration rate corresponding thereto, and
wherein the calculation unit calculates the communication parameter for reducing the power consumption.

6. (canceled)

7. (canceled)

8. The transmission device according to claim 1, wherein the calculation unit is trained using a tug of war (TOW) algorithm.

9. The transmission device according to claim 1, wherein the calculation unit calculates the communication parameter on the basis of a plurality of communication history information items obtained from results of communicating with a plurality of reception devices.

10. (canceled)

11. (canceled)

12. (canceled)

13. The transmission device according to claim 1,
wherein a signal transmitted to the reception device on the basis of the output communication parameter is encoded in an encoding scheme having an error detection function, and
wherein the deterioration rate is based on an error rate when a signal received from the reception device has been decoded.

14. The transmission device according to claim 1,
wherein the communication history information storage unit stores a plurality of communication history information items, and
wherein the calculation unit performs a calculation process by more strongly weighting newer information among the plurality of communication history information items.

15. (canceled)

16. The transmission device according to claim 1,
wherein the communication parameter includes a plurality of components, and
wherein the calculation unit calculates the communication parameter by selecting one of combinations of the plurality of components included in the communication parameter.

17. The transmission device according to claim 1,
wherein the information communication is a communication method in which a plurality of communication channels are defined in a predetermined frequency band, and
wherein the communication parameter includes a channel mask for identifying one or more channels that are included in the communication channels and are not used for the information communication to be performed with the reception device.

18. The transmission device according to claim 17,
wherein it is indicated that radio waves transmitted to the reception device do not deteriorate as the deterioration rate decreases, and
wherein the calculation unit decides on the communication parameter so that the deterioration rate decreases when communication with a specific other party is performed via the channel mask included in the calculated communication parameter.

19. (canceled)

20. The transmission device according to claim 19 dependent on claim 17,
wherein the communication method is advertising defined in a BLE standard, and
wherein the communication channel is an advertising channel defined in the BLE standard,
wherein the advertising is connectable advertising, and
wherein the deterioration rate is a value calculated on the basis of whether or not a connection request has been answered.

21. (canceled)

22. The transmission device according to claim 21,
wherein the advertising is advertising for receiving a scan request, and
wherein the deterioration rate is calculated on the basis of whether or not the scan request has been answered.

23. The transmission device according to claim 22, wherein the deterioration rate is calculated on the basis of the number of times one or more specific reception devices have received an advertising packet.

24. The transmission device according to claim 1, further comprising a wireless communication unit configured to perform the information communication with the reception device on the basis of the communication parameter output by the output unit,
wherein the communication parameter includes a first transmission interval, and
wherein the wireless communication unit transmits a signal to the reception device on the basis of the first transmission interval.

25. The transmission device according to claim 24,
wherein the wireless communication unit completes an information transmission process for the reception device during a transmission time period that is a time period from a start of signal generation to an end of transmission, and
wherein the calculation unit adjusts the communication parameter so that the transmission time period is decreased when the reception device has continuously and stably received information transmitted by the wireless communication unit.

26. The transmission device according to claim 25,
wherein the wireless communication unit performs a transmission process that is iterated during a period from the time of system activation to an assumed operating lifespan, and
wherein the calculation unit adjusts the communication parameter so that a total time period required for the information transmission process is decreased when the reception device has continuously and stably received information transmitted by the wireless communication unit.

27. The transmission device according to claim 24,
wherein the communication parameter includes a second transmission interval and a transmission count, and
wherein the wireless communication unit transmits second data different from first data on the basis of the second transmission interval after the first data obtained by encoding the same data is transmitted until a specific transmission count is reached on the basis of the first transmission interval.

28. The transmission device according to claim 27, wherein the calculation unit adjusts the communication parameter so that the transmission count is decreased when the reception device has continuously and stably received information transmitted by the wireless communication unit.

29. The transmission device according to claim 27, wherein the calculation unit adjusts the communication parameter so that the second transmission interval is increased when the reception device has continuously and stably received information transmitted by the wireless communication unit.

30. The transmission device according to claim 27, wherein the calculation unit adjusts the communication parameter so that the second transmission interval is increased when the reception device has not continuously received information transmitted by the wireless communication unit.

31. (canceled)

32. (canceled)

33. (canceled)

34. (canceled)

35. (canceled)

36. (canceled)

37. (canceled)

38. (canceled)
